(19) United States
(12) Patent Application Publication
(10) Pub. No.: US 2024/0317930 A1
(43) Pub. Date: Sep. 26, 2024

(54) RESIN COMPOSITION FOR OPTICAL WAVEGUIDE, AND DRY FILM AND OPTICAL WAVEGUIDE USING SAME

(71) Applicant: PANASONIC INTELLECTUAL PROPERTY MANAGEMENT CO., LTD., Osaka (JP)

(72) Inventors: Junko KURIZOE, Osaka (JP); Naoyuki KONDO, Osaka (JP); Toru NAKASHIBA, Osaka (JP)

(73) Assignee: PANASONIC INTELLECTUAL PROPERTY MANAGEMENT CO., LTD., Osaka (JP)

(21) Appl. No.: 18/573,312

(22) PCT Filed: Jun. 10, 2022
(86) PCT No.: PCT/JP2022/023511

§ 371 Date: Dec. 21, 2023

(30) Foreign Application Priority Data
Jun. 29, 2021 (JP) 2021-107421

(51) Int. Cl. C08G 59/40; C08G 59/24; C08L 63/00; G02B 1/04

(52) U.S. Cl. CPC C08G 59/4078; C08G 59/245; C08L 63/00; G02B 1/045; C08L 2205/025

(57) ABSTRACT

An aspect of the present invention relates to a resin composition for optical waveguide containing an epoxy resin and a curing agent, in which the number of aliphatic CH groups in the epoxy resin per unit volume is 0.055× Avogadro's number (N_{A}) (/cm³) or less in the resin composition for optical waveguide.

### TECHNICAL FIELD

The present invention relates to a resin composition for optical waveguide. The present invention further relates to a dry film and an optical waveguide core, which are obtained using such a resin composition.

### BACKGROUND ART

Conventionally, optical fiber has been the mainstream transmission medium in the fields of FTTH (Fiber to the Home) and long-distance and medium-distance communications in the in-vehicle field. In recent years, there has been a need for high-speed transmission using light in short distances of 1 m or less. For this region, optical waveguide type optical wiring boards are suitable that can be subjected to high density wiring (narrow pitch, branching, crossing, multilayering, and the like) and integration with electric substrates, be bent in a small diameter, and exhibit surface mountability, which cannot be attained by optical fibers.

Conventionally, it has been known to form optical waveguides by forming a cladding layer, core layer and the like using highly transparent resin materials, performing exposure by ultraviolet (UV) irradiation or the like, performing development, and then curing the resins. As such materials for optical waveguide, it has been reported to use a resin composition containing a liquid epoxy resin and a solid epoxy resin in order to suppress stickiness and improve productivity and workability (for example, Patent Literature 1).

Patent Literature 1 discloses a film material for optical waveguide in which an epoxy-based raw material as described above and a curing initiator by ultraviolet rays (photoacid generator) are formulated. However, by the studies of the present inventors, it is revealed that light in the wavelength band of 1.3 μm used for optical communication is absorbed and an optical loss of approximately 0.50 dB/cm occurs in the film material for optical waveguide having the formulation described above and other conventional materials. Therefore, there is a demand for a material for optical waveguide that can achieve even lower loss of light particularly in the 1.3 μm band.

Accordingly, it is an object of the present invention to improve the above-mentioned problems and provide a resin composition for optical waveguide that can suppress optical loss (particularly optical loss in the 1.3 μm band) more than conventionally used materials.

### CITATION LIST

### Patent Literature

Patent Literature 1: JP 2012-128360 A

### SUMMARY OF INVENTION

As a result of intensive investigation aimed at solving the problems, the present inventors have found that the problems can be solved by the following means.

In other words, a resin composition for optical waveguide according to an aspect of the present invention contains an epoxy resin, and a curing agent, in which a number of aliphatic CH groups in the epoxy resin per unit volume is 0.055× Avogadro's number (N_{A}) (/cm³) or less in the resin composition for optical waveguide.

### BRIEF DESCRIPTION OF DRAWINGS

FIG. 1A to FIG. 1F are schematic cross-sectional views for explaining an embodiment of a method for forming an optical waveguide using a resin composition of the present embodiment.

FIG. 2 is a schematic cross-sectional view illustrating the configuration of a slab waveguide fabricated in Example.

### DESCRIPTION OF EMBODIMENTS

The present inventors have conducted extensive studies aiming at further diminishing optical loss, and found that the functional group that absorbs overtones of a light beam having a wavelength of 1.3 μm used in optical communication is an aliphatic CH group. Based on this finding, the present inventors have found out that the absorption of light having a wavelength of 1.3 μm can be diminished and thus the optical loss can be suppressed by decreasing the number of aliphatic CH groups in the epoxy resin in a composition for optical waveguide, and completed the present invention. It has also found that a similar effect is observed in aromatic CH groups but the effect is greatly minor. This is presumed to be due to the fact that the same functional group has different ability to absorb light depending on the existing environment.

Hereinafter, embodiments for implementing the present invention will be described specifically, but the present invention is not limited thereto.

### [Resin Composition for Optical Waveguide]

The resin composition for optical waveguide of the present embodiment (hereinafter sometimes simply referred to as the resin composition) contains an epoxy resin and a curing agent. In the resin composition for optical waveguide, the number of aliphatic CH groups in the epoxy resin per unit volume is 0.055× Avogadro's number (N_{A}) (/cm³) or less.

By the configuration, it is possible to provide a resin composition for optical waveguide that can suppress optical loss (particularly, optical loss in the 1.3 μm band) more than conventional ones. By using the composition for optical waveguide, it is possible to provide an excellent dry film and an excellent optical waveguide.

First, a method for calculating the number of aliphatic CH groups will be described.

In the present embodiment, the CH number per unit volume (unit: number×Avogadro's number/cm³) is determined by the following equation.

CH number per unit volume=(number of CH numbers in structure)/(volume per one molecule)

In this embodiment, (volume per one molecule) is determined by the following equation.

(Volume per one molecule)=(molecular weight)/(specific gravity of molecule)

The method for calculating the number of aliphatic CH groups will be described using a calculation example. The structure of the bisphenol A type liquid epoxy resin (“850S” manufactured by DIC Corporation) used in Examples described later is as represented by the following chemical formula.

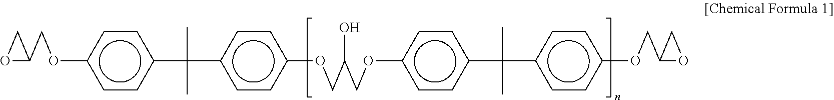

Since the epoxy resin has an epoxy equivalent weight of 188, it is estimated that n=0.13. Hence, in the chemical formula, the molecular weight derived from the structure outside the parentheses is 340.4, the total CH number is 24, and the aliphatic CH number (hereinafter also referred to as “ACH number”) is 16. The molecular weight derived from the structure in the parentheses is 284.3, the total CH number is 19, and the ACH number is 11.

Therefore, when calculated as a whole,

molecular weight: 340.4+284.3×0.13=377.4;

total CH number in one molecule: 24+19×0.13=26.47; and

aliphatic CH number in one molecule: 16+11×0.13=17.43.

Since the specific gravity of the epoxy resin “850S” is 1.15,

$$total CH number per unit volume = 16 , 47 \div ( 377.4 / 1.15 ) = 0.081 \times Avagadro ' s number / {cm}^{3} ; and$$

$$aliphatic CH number per unit volume = 17.43 \div ( 377.3 / 1.15 ) = 0.053 \times Avagadro ' s number / {cm}^{3} .$$

In this way, the aliphatic CH number in each raw material (epoxy resin) is determined, and then the aliphatic CH number in all epoxy resins is determined as follows in a case where the resin composition contains a plurality of epoxy resins.

Specifically:
in a case where the formulated ratio (weight) of epoxy resin A is a, the ACH number is a_{ACH}, and the specific gravity is a specific gravity;
the formulated ratio (weight) of epoxy resin B is b, the ACH number is b_{ACH}, and the specific gravity is b specific gravity; and
the formulated ratio (weight) of epoxy resin C is c, the ACH number is c_{ACH}, and the specific gravity is c specific gravity,
the aliphatic CH number (ACH number) in all epoxy resins can be determined by the following equation.

$$\frac{( {a}_{ACH} \times a ) / {a}_{Specific gravity} + ( {b}_{ACH} \times b ) / {b}_{Specific gravity} + ( {c}_{ACH} \times c ) / {c}_{Specific gravity}}{( a / {a}_{Specific gravity} + b / {b}_{Specific gravity} + c / {c}_{Specific gravity} )}$$

### (Epoxy Resin)

As the epoxy resin contained in the resin composition of the present embodiment, any epoxy resin can be used without particular limitation as long as the number of aliphatic CH groups in the epoxy resin per unit volume is 0.055× Avogadro's number (N_{A}) (/cm³) or less. The resin composition of the present embodiment may contain one kind of epoxy resin satisfying the ACH number, and in a case where two or more kinds of epoxy resins are contained, it is only required that the ACH number in the entire epoxy resin composed of the plurality of epoxy resins is the value described above.

More specifically, the epoxy resin used in the present embodiment may be a liquid epoxy resin or a solid epoxy resin. In the present embodiment, “liquid” means liquid at room temperature, and “solid” means solid at room temperature.

Examples of the liquid epoxy resin that can be used in the present embodiment include a bisphenol A type epoxy resin, a bisphenol F type epoxy resin, a bisphenol E type epoxy resin, a brominated epoxy resin, and an alicyclic epoxy resin.

Examples of the solid epoxy resin that can be used in the present embodiment include a bisphenol A type epoxy, a hydrogenated bisphenol A type epoxy resin, a bisphenol F type epoxy resin, a brominated epoxy resin, a fluorinated epoxy resin, an aromatic epoxy resin, a novolac type epoxy resin, a biphenyl skeleton type epoxy resin, and an alicyclic epoxy resin.

These can be used singly or in combination of two or more kinds thereof.

In a preferred embodiment, it is desirable to mainly use an aromatic epoxy resin as the epoxy resin of the present embodiment. The aliphatic CH groups can be thus effectively decreased. Specifically, for example, the epoxy resin of the present embodiment preferably contains at least one epoxy resin selected from a bisphenol A type epoxy resin having two or more epoxy groups or a bisphenol F type epoxy resin having two or more epoxy groups. These epoxy resins may be all solid epoxy resins or liquid epoxy resins. By containing such epoxy resins, low loss of light of 1.3 μm can be more reliably attained.

Furthermore, as the epoxy resin, it is preferable to contain a liquid epoxy resin and a solid epoxy resin, and thus it is possible to obtain a film-shaped material that is solid at room temperature (normal temperature) and it is considered that the handling property in the production process of optical waveguides is also improved. In a case where a liquid epoxy resin and a solid epoxy resin are contained in this way, the difference between the refractive index of the liquid epoxy resin and the refractive index of the solid epoxy resin is preferably 0.05 or less.

Furthermore, it is also preferable that the epoxy resin of the present embodiment contains a bisphenol AF type epoxy resin. A bisphenol AF type epoxy resin is a fluorine-containing epoxy resin, but also by using an epoxy resin in which some of CH groups are converted to CF groups in this way, it is possible to effectively decrease aliphatic CH groups. Similarly, it is preferable to use a brominated epoxy resin in which some of CH groups are converted to CBr groups.

It is also preferable that the epoxy resin of the present embodiment contains a solid aromatic epoxy resin having three or more epoxy groups. When such a polyfunctional epoxy resin is contained, there is an advantage that the heat resistance of the dry film and optical waveguide obtained from the resin composition of the present embodiment can be improved.

Epoxy resins of a preferred embodiment as described above can be all used singly or in combination of two or more kinds thereof.

In a case where the resin composition of the present embodiment contains both a liquid epoxy resin and a solid epoxy resin, the ratio of the liquid epoxy resin is preferably about 5% to 35% by mass with respect to the entire resin composition. When the ratio of the liquid epoxy resin is such a ratio, there is an advantage that the handling property is excellent when a dry film for optical waveguide and the like are produced as well. Meanwhile, the ratio of the solid epoxy resin is preferably about 65% to 95% by mass with respect to the entire resin composition. When the ratio of the solid epoxy resin is such a ratio, there is an advantage that the tackiness of the film before curing can be kept low and powder falling off and the like during handling can be suppressed.

Furthermore, in the resin composition of the present embodiment, the number of OH groups in the epoxy resin per unit volume is preferably 0.01× Avogadro's number (N_{A}) (/cm³) or less. In addition to a decrease in CH groups as described above, by decreasing the OH groups in the epoxy resin, it is considered that the optical loss of 1.3 μm due to OH group vibration can also be suppressed and a material for waveguide causing lower optical loss can be provided.

### (Curing Agent)

The resin composition of the present embodiment further contains a curing agent in addition to the epoxy resin described above. As the curing agent, for example, a photocuring agent capable of initiating curing by light (a photoacid generator that generates an acid by light, a photobase generator that generates a base by light, or the like) can be used. A thermal curing agent that can initiate curing by heat (a thermal acid generator that generates an acid by heat, a thermal base generator that generates a base by heat, or the like), or a photo/thermal curing agent that can initiate curing by light or heat may be used concurrently.

More specifically, an antimony-based curing agent, a phosphorus-based curing agent, a special phosphorus-based curing agent, a borate-based curing agent, and the like can be used as the photoacid generator. These can be used singly or in combination of two or more kinds thereof.

In the present embodiment, particularly by using antimony-based and special phosphorus-based curing agents among the curing agents, the curability and transparency can be further enhanced and optical loss can be reliably diminished.

In a case where the above-described epoxy resin contains a brominated epoxy resin, it is preferable to contain a borate-based curing agent as the curing agent since it is difficult to cure the brominated epoxy resin with a normal curing agent. By the principle of diffusion, there is a phenomenon in which liquid resins and low molecular weight solid resins diffuse and migrate to the exposed portion during the heat treatment process after exposure. A borate-based curing agent is sufficiently cured during diffusion and migration because of its strong curability, and is therefore likely to cause refractive index distribution inside the core. In that case, it is more preferable that, for example, the brominated epoxy resin contains a brominated epoxy resin A that is liquid at room temperature and a brominated epoxy resin B that is solid at room temperature and the difference between the refractive index of the brominated epoxy resin A and the refractive index of the brominated epoxy resin B is 0.005 or less.

In the present embodiment, the formulated proportion of a curing agent as described above is preferably, for example, in the range of 0.05% by mass or more and 5% by mass or less with respect to the total amount of resin components in the resin composition. When the content of the curing agent is in this range, there is an advantage that sufficient resin curing is achieved and the strength of the acid remaining in the cured product is kept low. A more preferable content of the curing agent is 0.2% by mass or more and 1.5% by mass or less.

### (Others)

Furthermore, the resin composition for optical waveguide according to the present embodiment may contain other additives, for example, sensitizers, antioxidants, curing accelerators, flame retardants, flame retardant promoters, and leveling agents, if necessary, in a range in which the effects of the present invention are not impaired.

### (Method for Producing Resin Composition)

The resin composition for optical waveguide of the present invention is usually prepared in the form of a varnish and used. Such a varnish is prepared, for example, as follows.

In other words, the varnish is obtained by selecting the formulation so that a varnish obtained by dissolving an epoxy resin as described above in a solvent at a predetermined proportion and further formulating a curing agent and, if necessary, other additives becomes solid at normal temperature by being dried to remove the solvent. The mixing proportions of the resin components and the solvent in the varnish are not particularly limited, and may be appropriately adjusted so that the varnish has a viscosity suitable to be applied (filled) on the base material surface in the state of varnish.

The organic solvent is not particularly limited, and examples thereof include aromatic hydrocarbons such as benzene and toluene, amides such as N,N-dimethylformamide (DMF), and ketones such as acetone and methyl ethyl ketone. These may be used singly or in combination of two or more kinds thereof.

The temperature when the components are dissolved in the solvent is about 50° C. to 80° C.

In order to form an optical waveguide using a resin composition as described above, a cured layer may be formed through a coating process of directly applying the varnish to the substrate surface and then drying the varnish, but it is preferable to use a dry film previously formed from the resin composition described above from the viewpoint of productivity. In the case of using such a dry film, an optical waveguide can be produced with high productivity without requiring a complicated coating process. In the case of using a dry film, there is also an advantage that the optical waveguide can be formed with a uniform thickness accuracy.

### (Dry Film)

The dry film according to the present embodiment is formed, for example, by applying the resin composition of the present embodiment to the surface of a base film such as a PET film using a multi coater with a comma coater head, or the like, and drying this. A dry film having a thickness of about 10 to 100 μm can be obtained by further heat laminating a polypropylene film or the like as a release film.

### (Optical Waveguide)

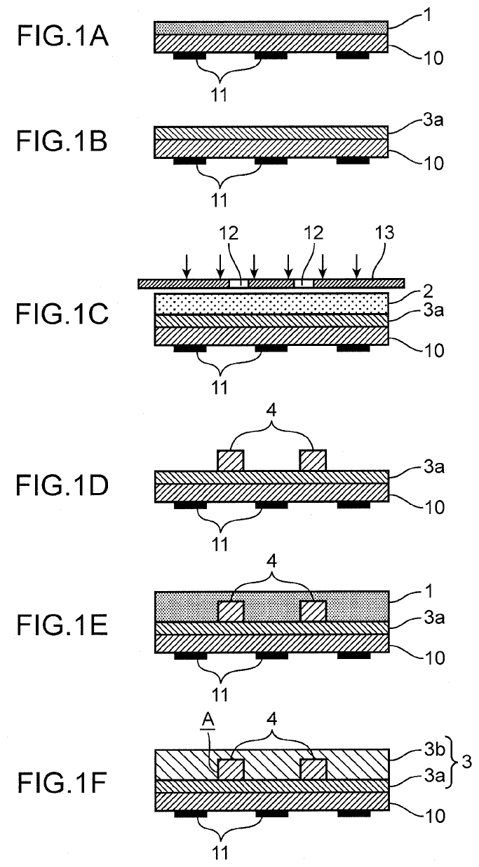

Next, an embodiment of forming an optical waveguide on a substrate using such a dry film will be described in detail with reference to FIG. 1. In the present specification, the respective symbols in the drawings indicate: 1 film for cladding, 2 optical film for core, 3 cladding, 3a undercladding, 3b overcladding, and 4 core.

In forming an optical waveguide, a film for cladding and a film for core are used to form a core and a cladding, respectively. The resin composition of the present embodiment can be used as both a material for cladding and a material for core, but the refractive index of the film for cladding is adjusted to be lower than the refractive index of the film for core.

First, as illustrated in FIG. 1A, a film for cladding 1 is laminated on the surface of a substrate 10 on which an electric circuit 11 is formed, and then the film for cladding 1 is cured by irradiation with light such as ultraviolet rays or by heating. As the substrate 10, for example, a flexible printed wiring board in which an electric circuit is formed on one surface of a transparent base material such as a polyimide film, a printed wiring board such as glass epoxy, or the like is used. Through such a process, an undercladding 3a is layered and formed on the surface of the substrate 10 as illustrated in FIG. 1B.

Next, as illustrated in FIG. 1C, a film for core 2 is laminated on the surface of the undercladding 3a, then a mask on which slits of a core pattern are formed is superimposed, and the core pattern is exposed to the optical film for core 2 by performing irradiation with light capable of photocuring such as ultraviolet rays through the slits. The exposure method may be a method in which selective exposure is performed using a mask, or a direct drawing method in which a laser beam is scanned along the pattern shape for irradiation.

Next, after exposure, the optical film for core 2 is developed using a developing solution such as an aqueous flux detergent to remove the resin from the unexposed and uncured portions of the optical film for core 2. As illustrated in FIG. 1D, a core 4 having a predetermined core pattern is thus formed on the surface of the undercladding 3a.

Next, as illustrated in FIG. 1E, a film for cladding 1 is laminated and layered so as to cover the undercladding 3a and the core 4. Then, by curing the film for cladding 1 by light irradiation or heating, an overcladding 3b as illustrated in FIG. 1F is formed. Thus, an optical waveguide A in which the core 4 is embedded in a cladding 3 composed of the undercladding 3a and the overcladding 3b is formed on the surface of the substrate 10.

As the resin composition of the present embodiment is used in the optical waveguide A thus obtained, the loss of light of 1.3 μm can be diminished and excellent optical communication can be achieved. Hence, the substrate 10 on which such an optical waveguide A is formed is preferably used as a printed wiring board for optical transmission, and for example, is preferably used in mobile phones, personal digital assistants, and the like.

Hereinafter, the present invention will be described more specifically with reference to Examples. The present invention is not limited by the following Examples at all.

### EXAMPLES

First, the materials used for the preparation of resin compositions in the present Examples are summarized below.

### <Liquid Epoxy>

“CELLOXIDE 2021P (CEL2021P)”: Alicyclic epoxy resin, manufactured by DAICEL CORPORATION (ACH number: 0.093, specific gravity: 1.17)
“EPICLON 850S”: Bisphenol A type epoxy resin, manufactured by DIC Corporation (ACH number: 0.056, specific gravity: 1.15)
“EPOX MK R1710”: Bisphenol E type epoxy resin, manufactured by PRINTEC CORPORATION (ACH number: 0.051, specific gravity: 1.2)
“BROC” Brominated epoxy resin, manufactured by Nippon Kayaku Co., Ltd. (ACH number: 0.043, specific gravity: 1.75, refractive index: 1.6052)

### <Solid Epoxy>

“VG3101M80”: Polyfunctional epoxy resin, manufactured by PRINTEC CORPORATION (ACH number: 0.048, specific gravity: 1.19)
“jER1001”: Bisphenol A type epoxy resin, manufactured by Mitsubishi Chemical Corporation (ACH number: 0.050, specific gravity: 1.19)
“NC3000”: Bisphenyl type epoxy resin, manufactured by Nippon Kayaku Co., Ltd. (ACH number: 0.034, specific gravity: 1.2)
“YX7760” Bisphenol AF type epoxy resin, manufactured by Mitsubishi Chemical Corporation (ACH number: 0.032, specific gravity: 1.47)
“Epikote 1006FS”: Bisphenol A type epoxy resin, manufactured by Mitsubishi Chemical Corporation (ACH number 0.048, specific gravity: 1.19)
“4005P”: Bisphenol F type epoxy resin, manufactured by Mitsubishi Chemical Corporation (ACH number 0.035, specific gravity: 1.19)
“EPICLON 153”: Brominated epoxy resin, manufactured by DIC Corporation (ACH number: 0.042, specific gravity: 1.8, refractive index: 1.6031)

### <Curing Agent>

“CPI-200K”: Special phosphorus-based cationic curing agent, manufactured by San-Apro Ltd.
“CPI-210S”: Special phosphorus-based cationic curing agent, manufactured by San-Apro Ltd.
“CPI-310B”: Borate-based cationic curing agent, manufactured by San-Apro Ltd.
“SP-170”: Antimony-based cationic curing agent (manufactured by ADEKA Corporation)

### <Additives>

“UVS-1331”: Sensitizer, Kawasaki Kasei Chemicals Ltd.
“AO-60”: Antioxidant, manufactured by ADEKA Corporation
“PEP36”: Antioxidant, manufactured by ADEKA Corporation
“PF636”: Leveling agent, manufactured by OMNOVA
“BYK3560”: Leveling agent, manufactured by BYK Japan KK

### <Preparation of Resin Composition>

### Examples 1 to 12 and Comparative Example

The components were formulated at the formulated composition (parts by mass) as presented in Table 1 below, adjusted so that the mixed solvent of MEK and toluene was 70 parts by mass with respect to 100 parts by mass of the resin, and mixed while being heated at 50° C. to 80° C. Next, the mixture was filtered through a membrane filter having a pore size of 1 μm and then defoamed, thereby preparing epoxy resin varnishes of the respective Examples and Comparative Example.

Table 1 also presents the refractive index n (1.3 μm wavelength), ACH number, and OH number of the epoxy resins used in the respective Examples and Comparative Example.

Regarding the preparation of resin compositions, the formulation was adjusted based on the refractive index n presented below.

### (Refractive Index n)

The refractive index (n) of the liquid component and the refractive index (n) of the entire core layer were determined as follows for the resin compositions of the respective Examples and Comparative Example.

The refractive index of each resin alone at a wavelength of 1.3 μm was measured using an Abbe refractometer. Among the epoxy resins, as for BROC (Nippon Kayaku Co., Ltd.) and EPICLON 153 (DIC Corporation), resin cured products obtained by curing the resins using CPI310B (manufactured by San-Apro Ltd.) as a curing agent were used as a sample for refractive index measurement, and as for resins other than these, resin cured products obtained by curing the resins using CPI101A (manufactured by San-Apro Ltd.) as a curing agent were used as a sample for refractive index measurement. The refractive index (n) of the liquid component and the refractive index (n) of the entire core layer were estimated by the following Equations 1 and 2 in advance using the refractive index values of the respective resins thus measured, and the formulation of resins was adjusted so that the difference between the refractive index (n) of the liquid epoxy resin and the refractive index of the entire resin composition for optical waveguide (resin composition for core layer) was 0.05 or less for the resin compositions of Examples.

Refractive index of liquid component={(refractive index of liquid resin a)×(parts by mass of liquid resin a)+(refractive index of liquid resin b)×(parts by mass of liquid resin b)+ . . . }/(parts by mass of liquid resin a+parts by mass of liquid resin b+ . . . .) (Equation 1)

Refractive index of entire core layer={(refractive index of liquid resin a)×(parts by mass of liquid resin a)+(refractive index of liquid resin b)×(parts by mass of liquid resin b)+ . . . +(refractive index of solid resin A)×(parts by mass of solid resin A)+(refractive index of solid resin B)×(parts by mass of solid resin B)+ . . . }/{(parts by mass of liquid resin a+parts by mass of liquid resin b+ . . . )+(parts by mass of solid resin A+parts by mass of solid resin B+ . . . .)} (Equation 2)

### <Measurement of Loss>

### Examples 1 to 10 and Comparative Example

The resin composition varnishes of the respective Examples and Comparative Example were applied to a PET film (product number A4100) manufactured by TOYOBO CO., LTD. using a multi coater with a comma coater head manufactured by HIRANO TECSEED Co., Ltd., and dried to a predetermined thickness, and heat laminated with a release film OPP-MA420 manufactured by Oji F-Tex Co., Ltd. to obtain a dry film having a resin layer thickness of 25 μm. This was used as a film for core.

As a cladding material for an optical waveguide, a dry film for cladding as described below was fabricated.

The respective components to be formulated of 14 parts by mass of CELLOXIDE 2021P (manufactured by DAICEL CORPORATION), 25 parts by mass of solid bisphenol A resin 1006FS (manufactured by Mitsubishi Chemical Corporation), 38 parts by mass of hydrogenated bisphenol A resin YX8040 (manufactured by Mitsubishi Chemical Corporation), 23 parts by mass of trifunctional epoxy resin VG3101L (manufactured by PRINTEC CORPORATION), 1 part by mass of SP-170 (manufactured by ADEKA Corporation) as a curing agent, 1.4 parts by mass of AO-60 (manufactured by ADEKA Corporation) as an antioxidant, and 0.1 part by mass of PF-636 (manufactured by OMNOVA) as a leveling agent were dissolved in a solvent, filtered through a membrane filter having a pore size of 1 μm, and defoamed to prepare an epoxy resin varnish. This varnish was applied to a PET film (product number A4100) manufactured by TOYOBO CO., LTD. using a multi coater with a comma coater head manufactured by HIRANO TECSEED Co., Ltd., and dried to obtain a film having a predetermined thickness.

Using the film for core and the film for cladding, the undercladding is first layered on the base material. Furthermore, a core film was layered thereon, exposure was performed using a mask capable of forming a pattern with a 25μ width, heat treatment was performed, then the unexposed core material was removed by development, and then the overcladding was layered, thereby fabricating a multimode waveguide sample having a core size of 25 μm.

Thereafter, light from an LED light source of 1310 nm was introduced into the end of the optical waveguide fabricated above through an optical fiber having a core diameter of 9 μm and an NA of 0.12 via silicone oil as a matching oil (refractive index of 1.505). From the opposite side, light was connected to a power meter through an optical fiber having a core diameter of 50 μm and an NA of 0.21 via the same matching oil, and the power (P1) in a case where an optical circuit was inserted was measured. The power (P0) was measured in a state of not having the optical circuit against which the two fibers were butted for measurement, and the insertion loss of an optical circuit was calculated by the calculation formula −10 log(P1/Po). The result is presented in Table 1 as material loss.

### Example 11

A dry film having a resin layer thickness of 50 μm was obtained in the same manner as in Example 1 using the resin composition varnish of Example 11. This was used as a film for core. As a material for cladding having a lower refractive index than the core, the same resin composition as in Example 1 was used to prepare a film for cladding having a thickness of 35 μm.

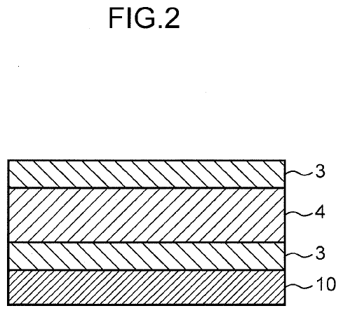

A slab waveguide as illustrated in FIG. 2 having a configuration in which the core 4 was sandwiched between two claddings 3 was then fabricated on the substrate 10 (“R1515W” manufactured by Panasonic Corporation).

Thereafter, light from an LED light source of 1310 nm was introduced into the end of the slab waveguide through an optical fiber having a core diameter of 9 μm and an NA of 0.12 via silicone oil as a matching oil (refractive index of 1.505), and light was received by a power meter from the opposite side. The power (P1) in a case where an optical circuit was inserted was measured, the power (P0) in a state of not having the slab waveguide was measured, and the insertion loss of an optical circuit was calculated by the calculation formula −10 log(P1/Po). The result is presented in Table 1 as material loss.

### Example 12

A dry film is fabricated for each of the material for core of μ and the material for cladding using the resin composition varnish of Example 12 by the method, and then the material for cladding is layered as an undercladding on the base material. Furthermore, a core film was layered thereon, exposure was performed using a mask capable of forming a pattern with a 6 to 7μ width, heat treatment was performed, then the unexposed core was removed by development, and then the overcladding was layered, thereby obtaining a waveguide sample.

Thereafter, light from an LED light source of 1310 nm was introduced into the end of the optical waveguide through an optical fiber having a core diameter of 9 μm and an NA of 0.12 via silicone oil as a matching oil (refractive index of 1.505). From the opposite side, light was connected to a power meter through an optical fiber having a core diameter of 50 μm and an NA of 0.21 via the same matching oil, the power (P1) in a case where an optical circuit was inserted was measured, the power (P0) was measured in a state of not having the optical circuit against which the two fibers were butted for measurement, and the insertion loss of an optical circuit was calculated by the calculation formula −10 log(P1/Po).

A waveguide for measurement was cut into a predetermined size to change the length, the same measurement was repeated, a graph was created with the waveguide length on the X-axis and the loss on the Y-axis, and the slope of the graph was taken as the propagation loss of waveguide. The result is presented in Table 1 as cutback loss.

TABLE 1

| | | | Refractive | | | Example | Example | Example | Example | Example |
|---|---|---|---|---|---|---|---|---|---|---|
| Component | | | index n 1.3μ | ACH | OH | 1 | 2 | 3 | 4 | 5 |
| Alicyclic epo | CEL2021P | Liquid | 1.5004 | 0.093 | 0.0000 | — | — | — | — | — |
| BisA | 850S | Liquid | 1.5641 | 0.053 | 0.0004 | 10 | 15 | 5 | 10 | 8 |
| BisE | R1710 | Liquid | 1.568 | 0.051 | 0.0000 | — | — | — | — | — |
| Polyfunctional epoxy | VG3101M80 | Solid | 1.5824 | 0.048 | 0.0000 | 90 | — | 80 | 20 | 80 |
| BisA | 1001 | Solid | 1.5682 | 0.050 | 0.0027 | | 85 | 15 | — | — |
| Biphenyl type epo | NC3000 | Solid | 1.614 | 0.034 | 0.0000 | — | — | — | 70 | — |
| BisAF | YX7760 | Solid | 1.5086 | 0.032 | 0.0002 | — | — | — | — | — |
| BisA | 1006FS | Solid | 1.5715 | 0.048 | 0.0034 | — | — | — | — | 12 |
| BisF | 4005P | Solid | 1.5872 | 0.035 | 0.0039 | — | — | — | — | — |
| BisBr | BROC | Liquid | 1.6052 | 0.043 | 0.0000 | — | — | — | — | — |
| BisBr | 153 | Solid | 1.6031 | 0.042 | 0.0005 | — | — | — | — | — |
| Curing agent | CPI-200K | | | | | 0.6 | 0.6 | — | — | — |
| | CPI-210S | | | | | — | — | 0.4 | 0.4 | 0.2 |
| | CPI-310B | | | | | — | — | — | — | — |
| | SP-170 | | | | | — | — | — | — | — |
| Sensitizer | UVS-1331 | | | | | — | — | — | — | 0.1 |
| Antioxidant | AO60 | | | | | 0.6 | 0.6 | — | — | 0.3 |
| | PEP36 | | | | | — | — | — | — | 0.1 |
| Leveling agent | PF636 | | | | | — | — | — | — | — |
| | BYK3560 | | | | | 0.15 | 0.15 | 0.15 | 0.15 | 0.2 |
| Refractive index of | | | | | | 1.5641 | 1.5641 | 1.5641 | 1.5641 | 1.5641 |
| liquid component (n) | | | | | | | | | | |
| Refractive index of | | | | | | 1.5806 | 1.5676 | 1.5794 | 1.6027 | 1.5796 |
| entire core (n) | | | | | | | | | | |
| Entire core (n) - | | | | | | 0.0165 | 0.0035 | 0.0153 | 0.0386 | 0.0155 |
| liquid component (n) | | | | | | | | | | |
| Material loss | dB/cm | | | | | 0.43 | 0.45 | 0.40 | 0.40 | 0.40 |
| Cutback loss | dB/cm | | | | | | | | | |
| Aliphatic CH | | | | | | 0.049 | 0.052 | 0.049 | 0.040 | 0.049 |
| OH | | | | | | 0.0000 | 0.0023 | 0.0004 | 0.0001 | 0.0004 |

| | | | | | | | | |
|---|---|---|---|---|---|---|---|---|
| | Example | Example | Example | Example | Example | Example | Example | Comparative |
| Component | 6 | 7 | 8 | 9 | 10 | 11 | 12 | Example |

| | | | | | | | | | |
|---|---|---|---|---|---|---|---|---|---|
| Alicyclic epo | CEL2021P | — | — | — | — | — | — | — | 23 |
| BisA | 850S | 8 | 25 | 15 | 21 | 18 | — | — | — |
| BisE | R1710 | — | — | — | — | — | — | 12 | — |
| Polyfunctional epoxy | VG3101M80 | 80 | 25 | 25 | 20 | | — | 15 | 21 |
| BisA | 1001 | — | — | 45 | 35 | 52 | — | — | — |
| Biphenyl type epo | NC3000 | — | — | — | — | — | — | — | — |
| BisAF | YX7760 | — | — | — | — | 7 | — | — | — |
| BisA | 1006FS | 12 | 50 | 15 | 24 | 23 | — | 18 | 56 |
| BisF | 4005P | — | — | — | — | — | — | 55 | — |
| BisBr | BROC | — | — | — | — | — | 12 | — | — |
| BisBr | 153 | — | — | — | — | — | 88 | — | — |
| Curing agent | CPI-200K | — | — | — | — | — | — | — | — |
| | CPI-210S | 0.4 | 0.4 | 0.4 | 0.3 | 0.3 | | 0.3 | |
| | CPI-310B | — | — | — | — | — | 0.1 | — | — |
| | SP-170 | — | — | — | — | — | | | 0.6 |
| Sensitizer | UVS-1331 | — | — | — | — | — | — | — | — |
| Antioxidant | AO60 | — | — | — | — | — | — | — | 0.3 |
| | PEP36 | — | — | — | — | — | — | — | — |
| Leveling agent | PF636 | — | — | — | — | — | — | — | 0.1 |
| | BYK3560 | 0.15 | 0.15 | 0.15 | 0.15 | 0.15 | 0.2 | 0.15 | — |
| Refractive index of | | 1.5641 | 1.5641 | 1.5641 | 1.5641 | 1.5641 | 1.6052 | 1.568 | 1.5004 |
| liquid component (n) | | | | | | | | | |
| Refractive index of | | 1.5796 | 1.5724 | 1.5716 | 1.5710 | 1.5640 | 1.6034 | 1.5814 | 1.5574 |
| entire core (n) | | | | | | | | | |
| Entire core (n) - | | 0.0155 | 0.0083 | 0.0075 | 0.0069 | −0.0001 | −0.0018 | 0.0133 | 0.0570 |
| liquid component (n) | | | | | | | | | |
| Material loss | dB/cm | 0.43 | 0.47 | 0.43 | 0.41 | 0.41 | 0.34 | | 0.60 |
| Cutback loss | dB/cm | | | | | | | 0.40 | |
| Aliphatic CH | | 0.049 | 0.050 | 0.051 | 0.051 | 0.050 | 0.042 | 0.041 | 0.058 |
| OH | | 0.0004 | 0.0018 | 0.0018 | 0.0018 | 0.0023 | 0.0005 | 0.0031 | 0.0019 |

### <Evaluation and Discussion>

From the results in Table 1, it was confirmed that according to the present invention, an optical waveguide that can keep the loss of light in the 1.3 μm band at a significantly low level (0.50 dB/cm or less) is obtained. Particularly in Example 11 in which a brominated epoxy resin is used, the loss can be kept at a lower level.

On the other hand, in the optical waveguide of Comparative Example, which does not meet the requirements of the present invention, an optical loss exceeding 0.50 dB/cm was measured.

Although the measurement method in Examples 1 to 10 and the measurement method in Example 11 are different from each other, the loss values determined by both measurement methods can be regarded as the loss due to the transparency of the material itself of the material used as the core, and are thus considered to be physical property values (material loss) at the same level. By the measurement method in Example 12, since the loss is estimated as a waveguide composed of a core and a cladding, the transparency of the cladding, the shape of the side surface of the core, and the like also affect the loss value. Therefore, in the case of performing measurement using the same material, the cutback loss of Example 12 is larger than the loss values by the measurement methods used in Example 1 and Example 11. Considering these, it is clear that Example 12 has lower loss, although the measurement method in Example 12 and the measurement method in Comparative Example are different from each other.

This application is based on Japanese Patent Application No. 2021-107421 filed on Jun. 29, 2021, the contents of which are included in the present application.

In order to express the present invention, the present invention has been described above appropriately and sufficiently through the embodiments with reference to specific examples, drawings and the like. However, it should be recognized by those skilled in the art that changes and/or improvements of the above-described embodiments can be readily made. Accordingly, changes or improvements made by those skilled in the art shall be construed as being included in the scope of the claims unless otherwise the changes or improvements are at the level which departs from the scope of the appended claims.

### INDUSTRIAL APPLICABILITY

The present invention has wide industrial applicability in technical fields such as optical waveguides, various electronic devices, and optical devices.

1. A resin composition for optical waveguide comprising an epoxy resin; and a curing agent,
wherein a number of aliphatic CH groups in the epoxy resin per unit volume is 0.055× Avogadro's number (N_{A}) (/cm³) or less in the resin composition for optical waveguide.

2. The resin composition for optical waveguide according to claim 1, wherein the epoxy resin contains at least one epoxy resin selected from a bisphenol A type epoxy resin having two or more epoxy groups or a bisphenol F type epoxy resin having two or more epoxy groups.

3. The resin composition for optical waveguide according to claim 1, wherein the epoxy resin contains a bisphenol AF type epoxy resin.

4. The resin composition for optical waveguide according to claim 1, wherein the epoxy resin contains a solid aromatic epoxy resin having 3 or more epoxy groups.

5. The resin composition for optical waveguide according to claim 1, wherein a number of OH groups in the epoxy resin per unit volume is 0.01× Avogadro's number (N_{A}) (/cm³) or less in the resin composition for optical waveguide.

6. The resin composition for optical waveguide according to claim 1, wherein
the epoxy resin contains a liquid epoxy resin and a solid epoxy resin, and
a difference between a refractive index of the liquid epoxy resin and a refractive index of the entire resin composition for optical waveguide is 0.05 or less.

7. The resin composition for optical waveguide according to claim 1, wherein the epoxy resin contains a brominated epoxy resin and the curing agent contains a borate-based curing agent.

8. The resin composition for optical waveguide according to claim 7, wherein
the brominated epoxy resin contains a liquid brominated epoxy resin A and a solid brominated epoxy resin B, and
a difference between a refractive index of the brominated epoxy resin A and a refractive index of the brominated epoxy resin B is 0.005 or less.

9. A dry film comprising: a cured product of the resin composition for optical waveguide according to claim 1; and a base film.

10. An optical waveguide comprising: the resin composition for optical waveguide according to claim 1.

11. An optical waveguide comprising the dry film according to claim 9.
